(19) United States
(12) Patent Application Publication
(10) Pub. No.: US 2021/0198449 A1
(43) Pub. Date: Jul. 1, 2021

(54) HIGHLY FILLED PLASTISOLS

(71) Applicant: Eastman Chemical Company, Kingsport, TN (US)

(72) Inventor: Curtis Louis Schilling, III, Kingsport, TN (US)

(73) Assignee: Eastman Chemical Company, Kingsport, TN (US)

(21) Appl. No.: 17/057,917

(22) PCT Filed: May 29, 2019
(86) PCT No.: PCT/US2019/034255

§ 371 Date: Nov. 23, 2020

Related U.S. Application Data
(60) Provisional application No. 62/681,751, filed on Jun. 7, 2018.

(51) Int. Cl. C08K 5/12; C08L 27/06; C08K 3/22; C08K 5/521

(52) U.S. Cl. CPC C08K 5/12; C08L 27/06; C08K 2003/2206; C08K 5/521; C08K 3/22

(57) ABSTRACT

The present application discloses low cost plastisols with high filler loading and gel points below 77° C.

### BACKGROUND OF THE INVENTION

Plastisols are useful in a variety of coating and adhesive applications such as in textiles, carpeting, paints, clear coatings, adhesives, sealants, caulking, nonwoven binders and a variety of similar applications. In the woven and nonwoven fabrics, a backing is applied to the fabric. Backings are applied to carpets, carpet tiles, moldable carpets, liners, covers, mats, moldable mats, rugs, moldable rugs, and other applications. Backings can be used to obtain fiber-lock performance and tuft-lock performance, give stability and structural integrity to the fabric, and afford non-skid characteristics. For example, carpet structures typically have nylon fibers bonded, tufted, or otherwise joined to a primary backing layer, collectively referred to as a face cloth. The face cloth is then bonded to a secondary backing. Such backings can be made with PVC based plastisols that are capable of imparting the desired support and durability to the carpet structure.

Fillers are often added to the plastisol compositions to save on costs. However, too much filler can result in highly viscose plastisol compositions that are unmanageable. Additionally, too much filler can result in poor physical properties (e.g., gel point, fusion point,) of the cured plastisol composition.

Carpet products, including carpet tiles, typically have a fiber-containing pile face attached to a primary backing and, attached to the underside of the primary backing, a multi-component secondary backing containing a variety of materials that impart desired physical properties, including weight, stability, stiffness, durability, under-foot comfort, and resistance to cupping and curling, among other properties.

Applicants have discovered a new low cost, high filler PVC plastisol that maintains a manageable viscosity profile. The high filler plastisol composition also maintains a gel point of less than 75° C. The PVC plastisol can be used in the preparation of articles, such as carpets, and used specifically in carpet backings.

### SUMMARY OF THE INVENTION

The present application discloses a plastisol comprising:
(1) 100 parts per hundred resin (“phr”) of a polyvinyl chloride composition;
(2) 20 to 140 phr of a plasticizer component comprising:
   (i) 10 to 40 wt % a highly solvating plasticizer, and
   (ii) 60 to 90 wt % a general-purpose plasticizer;
(3) 0.1 to 19 phr of a phosphate ester; and
(4) 325 to 475 phr of a filler,
wherein the weight ratio of filler to phosphate ester is from 3250:1 to 25:1.

The application also discloses articles made with the plastisols and fused plastisols, and methods of using the plastisols.

### DETAILED DESCRIPTION OF THE INVENTION

As used herein, the terms “a,” “an,” and “the” mean one or more.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

As used herein, the term “alkyl” shall denote a univalent group formed by removing a hydrogen atom from a non-aromatic hydrocarbon, and may include heteroatoms. Alkyl groups suitable for use herein can be straight, branched, or cyclic, and can be saturated or unsaturated. Alkyl groups suitable for use herein include any (C₁₋₂₀), (C₁₋₁₂), (C₁₋₅), or (C₁₋₃) alkyl groups. In various embodiments, the alkyl can be a C₁₋₅ straight chain alkyl group. In still other embodiments, the alkyl can be a C₁₋₃ straight chain alkyl group. Specific examples of suitable alkyl groups include, but are not limited to, methyl, ethyl, n-propyl, isopropyl, n-butyl, isobutyl, sec-butyl, tert-butyl, pentyl, hexyl, octyl, decyl, dodecyl, cyclopentyl, decyl, tridecyl, isotridecyl, and cyclohexyl groups.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the lettering of process steps or ingredients is a convenient means for identifying discrete activities or ingredients and the recited lettering can be arranged in any sequence, unless otherwise indicated.

As used herein the term “chosen from” used with the terms “and’ or “or when used in a list of two or more items, means that any one of the listed items can be employed by itself in the case of “chosen from” in conjunction with “and,” or means that any one of the listed items can be employed by itself or in any combination in the case of “chosen from” in conjunction with “or,” or any combination of two or more of the listed items can be employed. For example, if a composition is described as chosen from A, B, and C, the composition can contain A alone; B alone; or C alone. For example, if a composition is described as chosen from A, B, or C, the composition can contain A alone; B alone; C alone; A and B in combination; A and C in combination; B and C in combination; or A, B, and C in combination.

“Fast-fusing plasticizer” or “highly solvating plasticizer” generally refers to chemicals which are highly compatible with PVC up to at least about 150 per hundred parts resin (phr). Fast-fusing plasticizers tend to increase flexibility of the underlying polymer by directly interacting with the polymer. Highly solvating plasticizers tend to lower fusion temperatures and times of the PVC plastisol, but can have a negative impact by raising viscosity of a plastisol. Non-limiting examples of highly solvating plasticizers include di-butyl terephthalate (“DBT”).

General purpose plasticizer is a commercially available primary plasticizer that offers optimum cost/performance characteristics. A primary plasticizer is a plasticizer used in major proportion of the plasticizer system or blend to impart the major performance characteristics that are desired. Examples of commercially available general purpose plasticizers include, but are not limited to dioctyl terephthalate (also written as bis(2-ethylhexyl) benzene-1,4-dicarboxylate, di(2-ethylhexyl) terephthalate, DOTP), di-isononyl phthalate (also written as DINP), dioctyl phthalate (also written as bis(2-ethylhexyl) phthalate, (di-2-ethylhexyl phthalate, DEHP, or DOP), and 1,2-cyclohexane dicarboxylic acid diisononyl ester (also written as DINCH).

Parts per hundred resin (“phr”) refers to parts of additive per one hundred parts of base polymer (e.g., polyvinyl chloride or PVC).

As used, herein, the term “plastisol” refers to a liquid dispersion of polymeric resin particles, optionally with other ingredients, in a plasticizer. The term “fused plastisol” refers to the solid plastic material that is formed upon fusing the plastisol and subsequently cooling to a desired temperature. The term “fusing” refers to heating of the plastisol to a temperature sufficient to yield a solid structure with mechanical integrity upon cooling.

The polyvinyl chloride (“PVC”) composition can comprise several types of PVC polymers. For example, the PVC polymer can be a homopolymer or a copolymer. In one embodiment, the polyvinyl chloride composition comprises a polyvinyl chloride polymer chosen from a homopolymeric polyvinyl chloride polymer, a copolymeric polyvinyl chloride polymer, or a combination.

In one class of this embodiment, the polyvinyl chloride composition comprises 100 wt % of the homopolymeric polyvinyl chloride polymer.

In one class of this embodiment, the polyvinyl chloride composition comprises from 10 to 100 wt % of the homopolymeric polyvinyl chloride polymer.

In one class of this embodiment, the polyvinyl chloride composition comprises from 20 to 100 wt % of the homopolymeric polyvinyl chloride polymer.

In one class of this embodiment, the polyvinyl chloride composition comprises from 30 to 100 wt % of the homopolymeric polyvinyl chloride polymer.

In one class of this embodiment, the polyvinyl chloride composition comprises from 40 to 100 wt % of the homopolymeric polyvinyl chloride polymer.

In one class of this embodiment, the polyvinyl chloride composition comprises from 50 to 100 wt % of the homopolymeric polyvinyl chloride polymer.

In one class of this embodiment, the polyvinyl chloride composition comprises from 60 to 100 wt % of the homopolymeric polyvinyl chloride polymer.

In one class of this embodiment, the polyvinyl chloride composition comprises from 70 to 100 wt % of the homopolymeric polyvinyl chloride polymer.

In one class of this embodiment, the polyvinyl chloride composition comprises from 80 to 100 wt % of the homopolymeric polyvinyl chloride polymer.

In one class of this embodiment, the polyvinyl chloride composition comprises from 30 to 70 wt % of the homopolymeric polyvinyl chloride polymer.

In one class of this embodiment, the polyvinyl chloride composition comprises a polyvinyl chloride polymer that is a dispersion resin, a polyvinyl chloride polymer that is a blending resin, or combinations.

It is common in some plastisol formulations to substitute a substantially chemically inert material to impact desired physical properties such as hardness, compression set, or electrical resistivity. The inert material is commonly called filler and can significantly reduce the cost of the formulation. Non-limiting examples of fillers include calcium carbonate, magnesium carbonate, silica, clay, mica, graphite, fly ash, zinc oxide, and/or calcium oxide. In one embodiment, the filler is comprises calcium carbonate, magnesium carbonate, silica, clay, mica, graphite, fly ash, zinc oxide, dirt, or calcium oxide. In one embodiment, the filler comprises calcium carbonate. In one embodiment, the filler comprises fly ash.

In one embodiment, the filler is present from 325 to 500 phr. In one embodiment, the filler is present from 350 to 475 phr. In one embodiment, the filler is present from 375 to 475 phr. In one embodiment, the filler is present from about 400 to 475 phr. In one embodiment, the filler is present from 425 to about 475 phr. In one embodiment, the filler is present from about 450 to about 475 phr. In one embodiment, the filler is present in the plastisol at greater than 350 phr. In one embodiment, the filler is present in the plastisol at greater than 400 phr.

The viscosity of the plastisol can vary over a wide range but, for practical purposes, there is a minimum/maximum viscosity limit for every production process. The impact of shear on the plastisol viscosity is also important as the shear regime of a process changes significantly with respect to the equipment employed. Additionally, some mixtures can exhibit shear-thinning or shear-thickening behavior (dilatency). Dilatency can negatively impact a production process by creating excessive pressure at roll nips, doctor blades, and coating rolls. Coupled with the impact of shear, viscosity stability over time is important in a production process where plastisol may need to be stored for several days. The ability to consistently control the viscosity of a plastisol in a production process is highly valuable.

In one embodiment, the plastisol has a dynamic viscosity of less than 50,000 centipoise as measured according to ASTM D2983 at 22° C. at 2 revolutions per minute (“rpm”) after standing for 24 hours. In one embodiment, the plastisol has a dynamic viscosity of less than 40,000 centipoise as measured according to ASTM D2983 at 22° C. at 2 revolutions per minute (“rpm”) after standing for 24 hours. In one embodiment, the plastisol has a dynamic viscosity of less than 30,000 centipoise as measured according to ASTM D2983 at 22° C. at 2 revolutions per minute (rpm”) after standing for 24 hours. In one embodiment, the plastisol has a dynamic viscosity of less than 25,000 centipoise as measured according to ASTM D2983 at 22° C. at 2 revolutions per minute (“rpm”) after standing for 24 hours. In one embodiment, the plastisol has a dynamic viscosity of less than 20,000 centipoise as measured according to ASTM D2983 at 22° C. at 2 revolutions per minute (“rpm”) after standing for 24 hours. In one embodiment, the plastisol has a dynamic viscosity in the range of from 10,000 to 50,000 centipoise as measured according to ASTM D2983 at 22° C. at 2 revolutions per minute (“rpm”) after standing for 24 hours. In one embodiment, the plastisol has a dynamic viscosity in the range of from of from 10,000 to 40,000 centipoise as measured according to ASTM D2983 at 22° C. at 2 revolutions per minute (“rpm”) after standing for 24 hours. In one embodiment, the plastisol has a dynamic viscosity in the range of from of from 10,000 to 30,000 centipoise as measured according to ASTM D2983 at 22° C. at 2 revolutions per minute (“rpm”) after standing for 24 hours. In one embodiment, the plastisol has a dynamic viscosity in the range of from of from 20,000 to 30,000 centipoise as measured according to ASTM D2983 at 22° C. at 2 revolutions per minute (“rpm”) after standing for 24 hours.

In one embodiment, the plastisol viscosity is stable for time periods in excess of 7 days. In one embodiment, the plastisol viscosity is stable for time periods in excess of 6 days. In one embodiment, the plastisol viscosity is stable for time periods in excess of 5 days. In one embodiment, the plastisol viscosity is stable for time periods in excess of 4 days. In one embodiment, the plastisol viscosity is stable for time periods in excess of 3 days. In one embodiment, the plastisol viscosity is stable for time periods in excess of 2 days.

In one embodiment, the plastisol comprises 30 to 80 phr of the plasticizer component. In one embodiment, the plastisol comprises 30 to 70 phr of the plasticizer component. In one embodiment, the plastisol comprises 30 to 60 phr of the plasticizer component. In one embodiment, the plastisol comprises 30 to 50 phr of the plasticizer component. In one embodiment, the plastisol comprises 30 to 120 phr of the plasticizer component. In one embodiment, the plastisol comprises 40 to 120 phr of the plasticizer component. In one embodiment, the plastisol comprises 30 to 100 phr of the plasticizer component. In one embodiment, the plastisol comprises 20 to 100 phr of the plasticizer component.

In one embodiment, the plasticizer component comprises 10 to 30 wt % of a highly solvating plasticizer, and 70 to 90 wt. % a general-purpose plasticizer. In one embodiment, the plasticizer component comprises 20 to 40 wt % of a highly solvating plasticizer, and 60 to 80 wt. % a general-purpose plasticizer. In one embodiment, the plasticizer component comprises 20 to 30 wt % of a highly solvating plasticizer, and 70 to 80 wt. % a general-purpose plasticizer.

In one embodiment, the phosphate ester is

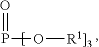

wherein each R¹ is independently chosen from hydrogen or

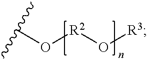

each R² is independently an (C₂₋₄)alkylene; each R³ is independently an (C₁₋₂₀)alkyl; and n is an integer from 1 to 20.

In one class of this embodiment, one R¹ group is hydrogen. In one class of this embodiment, two R¹ groups are each hydrogen. In one class of this embodiment, none of the R¹ groups is hydrogen.

In one class of this embodiment, each R² is independently ethylene, propylene, or butylene. In one subclass of this class, n is from 2-15.

In one class of this embodiment, each R² is independently ethylene. In one subclass of this class, n is from 2-15.

In one class of this embodiment, each R² is independently propylene. In one subclass of this class, n is from 2-15.

In one class of this embodiment, each R² is independently butylene. In one subclass of this class, n is from 2-15.

In one class of this embodiment, each R³ is independently methyl, ethyl, propyl, butyl, pentyl, hexyl, heptyl, octyl, nonyl, decyl, undecyl, dodecyl, tridecyl, isotridecyl, tetradecyl, pentadecyl, hexadecyl, heptadecyl, octadecyl, nonadecyl, and icosanyl. In one class of this embodiment, each R³ is independently hexyl, heptyl, octyl, nonyl, decyl, undecyl, dodecyl, tridecyl, isotridecyl, tetradecyl, pentadecyl, hexadecyl, heptadecyl, octadecyl, nonadecyl, and icosanyl. In one class of this embodiment, each R³ is independently decyl, undecyl, dodecyl, tridecyl, isotridecyl, tetradecyl, pentadecyl, hexadecyl, heptadecyl, octadecyl, nonadecyl, and icosanyl. In one class of this embodiment, each R³ is independently is isotridecyl.

In one embodiment, R² is ethylene; and R³ is (C₆₋₁₈)alkyl. In one class of this embodiment, R³ is isotridecyl. In one subclass of this class, n is 2-15. In one class of this embodiment, n is 2-15.

In one embodiment, R² is propylene; and R³ is (C₆₋₁₈)alkyl. In one class of this embodiment, R³ is isotridecyl. In one subclass of this class, n is 2-15. In one class of this embodiment, n is 2-15.

In one embodiment, R² is butylene; and R³ is (C₆₋₁₈)alkyl. In one class of this embodiment, R³ is isotridecyl. In one subclass of this class, n is 2-15. In one class of this embodiment, n is 2-15.

In one embodiment, R² is propylene; and R³ is (C₆₋₁₈)alkyl. In one class of this embodiment, R³ is isotridecyl. In one subclass of this class, n is 2-15. In one class of this embodiment, n is 2-15.

In one embodiment, R² is butylene; and R³ is (C₆₋₁₈)alkyl. In one class of this embodiment, R³ is isotridecyl. In one subclass of this class, n is 2-15. In one class of this embodiment, n is 2-15.

In one embodiment, n is an integer from 1 to 5. In one embodiment, n is an integer from 6 to 10. In one embodiment, n is an integer from 11 to 15. In one embodiment, n is an integer from 16 to 20. In one embodiment, n is an integer from 2 to 15.

In one embodiment, the phosphate ester is present at from 0.1 to 5.0 phr. In one embodiment, the phosphate ester is present at from 5.0 to 10.0 phr. In one embodiment, the phosphate ester is present at from 10 to 19 phr. In one embodiment, the phosphate ester is present at from 0.5 to 3.0 phr. In one embodiment, the phosphate ester is present at from 0.5 to 2.0 phr. In one embodiment, the phosphate ester is present at from 0.5 to 1.0 phr. In one embodiment, the phosphate ester is present at from 0.1 to 1.5 phr.

In one embodiment, the gel point of the plastisol is less than 85° C. as measured according to an adaptation of ASTM D2538 using a parallel plate rheometer. In one embodiment, the gel point of the plastisol is less than 80° C. In one embodiment, the gel point of the plastisol is less than 77° C. as measured according to an adaptation of ASTM D2538 using a parallel plate rheometer. In one embodiment, the gel point of the plastisol is less than 76° C. as measured according to an adaptation of ASTM D2538 using a parallel plate rheometer. In one embodiment, the gel point of the plastisol is less than 75° C. as measured according to an adaptation of ASTM D2538 using a parallel plate rheometer. In one embodiment, the gel point of the plastisol is less than 74° C. as measured according to an adaptation of ASTM D2538 using a parallel plate rheometer.

In one embodiment, the gel point of the plastisol in the range of from 74° C. to 84° C. as measured according to an adaptation of ASTM D2538 using a parallel plate rheometer. In one embodiment, the gel point of the plastisol in the range of from 74° C. to 80° C. as measured according to an adaptation of ASTM D2538 using a parallel plate rheometer. In one embodiment, the gel point of the plastisol in the range of from 74° C. to 77° C. as measured according to an adaptation of ASTM D2538 using a parallel plate rheometer. In one embodiment, the gel point of the plastisol in the range of from 72° C. to 84° C. as measured according to an adaptation of ASTM D2538 using a parallel plate rheometer. In one embodiment, the gel point of the plastisol in the range of from 72° C. to 80° C. as measured according to an adaptation of ASTM D2538 using a parallel plate rheometer. In one embodiment, the gel point of the plastisol in the range of from 72° C. to 77° C. as measured according to an adaptation of ASTM D2538 using a parallel plate rheometer.

The plastisols disclosed in the current application can be used in the preparation of various articles using plastisols. The plastisols can be used generally preparing carpet backings.

The present application discloses an article comprising a fused plastisol prepared from the plastisols disclosed herein. In one embodiment, the article is a carpet or a floor covering. In one class of this embodiment, the fused plastisol is part of the backing of the carpet or floor covering.

The present application discloses a flooring layer (e.g., carpet backing”) prepared with the plastisols disclosed herein. In one embodiment, the plastisol disclosed herein is used as a pre-coat binder or a secondary backing binder.

The present application discloses a method for producing an article, comprising: using the plastisol disclosed herein to produce an article. In one embodiment, the article is a flooring layer (e.g., carpet backing).

### EXPERIMENTAL SECTION

The following examples are given to illustrate the compositions and should not be construed as limiting in scope.

### Abbreviations

DOTP is di-ethylhexyl terephthalate; Pz is plasticizer(s); phr is parts per hundred resin; PVC is polyvinyl chloride; B1046 is 2,2,4-trimethyl-1,3-pentanediol isobutyrate dibenzoate; Ex is example; Comp ex is comparative example; ° C. is degree(s) Celsius; rpm is revolutions per minute.

### List of Chemicals Used

Vestolit G 138 copolymer PVC resin (Mexichem)
Formolon F28 homopolymer PVC resin (Formosa)
Formolon F260 homopolymer PVC resin (Formosa)

### Celceram PV20A Fly Ash

Eastman 168™ non-phthalate plasticizer (“DOTP”)

### Eastman™ DBT

### Eastman Benzoflex™ 1046 Plasticizer

### Lecithin (Archer Daniels Midland)

### Disperbyk®—102 (BYK)

### Viscobyk® 4010

### CaO (Aldrich)

### Evaluation of Plastisols

### Dynamic Viscosity

Viscosity measurements were acquired using ASTM D2983. The measurements were conducted at 2 and 20 rpm at 22° C. after the samples were equilabrated for 24 hours.

### Gel Point

Samples were analyzed on a TA Instruments AR-2000 parallel plate rheometer, fitted with an Environmental Test Chamber, 25 mm parallel plate geometry, set to a 1000-micron gap. A temperature sweep from 104-302° F. was run in oscillation mode with a heating rate of 41° F./min. On the resulting plots, the temperature where the G′/G″ plots cross is taken as an indication of the gel point.

### Fusion Temperature

Samples were analyzed on a TA Instruments AR-2000 parallel plate rheometer, fitted with an Environmental Test Chamber, 25 mm parallel plate geometry, set to a 1000-micron gap. A temperature sweep from 104-302° F. was run in oscillation mode with a heating rate of 41° F./min. On the resulting plots, the temperature at the maximum of the complex viscosity curve is taken as proxy for the fusion temperature.

### Preparation of Example 2

To a Flacktek Max 300 container was added 20 g of Vestolit G 138 dispersion resin, 30 g of Formolon F28 dispersion resin, and 22 g of Formolon F260 blending resin. To the resin blend was added 262 g of Celceram PV20A fly ash. To this was added 64 g of VersaMax Plus plasticizer, 1 g of soya lecithin, and 1 g of Calcium Oxide. The container was closed and mixed for three cycles of one minute at 1000 rpm. The container was removed after each cycle and scraped down to ensure sufficient incorporation of the solids. The resulting plastisol was de-aerated for 5 minutes at 75 torr and 800 rpm. The resulting plastisol was used without further processing. The final proportions are as follows for the following chemicals: Vestolit G 138, Formolon F28, Formolon F260, VersaMax Plus (DOTP:DBT, 70:30), Celceram PV20A fly ash, Disperbyk 102 is 28 phr, 42 phr, 30 phr, 89 phr, 364 phr, 3.6 phr, respectively.

The Plastisols in Table 1 were prepared by adapting the procedure for the preparation of Ex 2. Each sample also includes soya lecithin (1 g), and calcium oxide (1 g).

TABLE 1
Plastisol Formulations for Ex 1-9.

| | | | | | Wetting |
|---|---|---|---|---|---|
| | 100 phr PVC | | | Celceram | Agent/ |
| | Copolymer | Homopolymer | | PV20A Fly | Rheology |
| | PVC Resin | PVC Resin | | Ash Filler | Modifier |
| Ex # | (wt %) | (wt %) | Pz (phr) | (phr) | (phr) |
| 1 | Vestolit G | Formolon | 70:30 | 364 | Disperbyk |
| | 138 (28) | F260 (30), | DOTP:DBT | | 102 (1.8) |
| | | Formolon | (89.0) | | |
| | | F28 (42) | | | |
| 3 | Vestolit G | Formolon | 70:30 | 400 | Disperbyk |
| | 138 (28) | F260 (30), | DOTP:DBT | | 102 (4.0) |
| | | Formolon | (89.0) | | |
| | | F28 (42) | | | |
| 4 | Vestolit G | Formolon | 70:30 | 425 | Disperbyk |
| | 138 (28) | F260 (30), | DOTP:DBT | | 102 (4.2) |
| | | Formolon | (89.0) | | |
| | | F28 (42) | | | |
| 5 | Vestolit G | Formolon | 70:30 | 450 | Disperbyk |
| | 138 (28) | F260 (30), | DOTP:DBT | | 102 (4.5) |
| | | Formolon | (89.0) | | |
| | | F28 (42) | | | |
| 6 | Vestolit G | Formolon | 60:40 | 364 | Disperbyk |
| | 138 (28) | F260 (30), | DOTP:DBT | | 102 (3.6) |
| | | Formolon | (89.0) | | |
| | | F28 (42) | | | |
| 7 | Vestolit G | Formolon | 50:50 | 364 | Disperbyk |
| | 138 (28) | F260 (30), | DOTP:DBT | | 102 (3.6) |
| | | Formolon | (89.0) | | |
| | | F28 (42) | | | |
| 8 | Vestolit G | Formolon | 70:30 | 425 | Disperbyk |
| | 138 (28) | F260 (30), | DOTP:DBT | | 102 (4.2) |
| | | Formolon | (89.0) | | |
| | | F28 (42) | | | |
| 9 | Vestolit G | Formolon | 70:30 | 364 | Disperbyk |
| | 138 (70) | F260 (30) | DOTP:DBT | | 102 (3.6) |
| | | | (89.0) | | |

The Plastisols in Table 2 were prepared by adapting the procedure for the preparation of Ex 2. Each sample also includes soya lecithin (1 g), and calcium oxide (1 g).

TABLE 2
Plastisol formulations for Comparative
Ex 1-9, without wetting agents.

| | 100 phr PVC | | | Celceram |
|---|---|---|---|---|
| | Copolymer | Homopolymer | | PV20A Fly |
| Comp. | PVC Resin | PVC Resin | | Ash Filler |
| Ex # | (phr) | (phr) | Pz (phr) | (phr) |
| 1 | Vestolit G | Formolon | 70:30 | 350 |
| | 138 (28) | F260 (30), | DOTP:DBT | |
| | | Formolon | (89.0) | |
| | | F28 (42) | | |
| 2 | Vestolit G | Formolon | 70:30 | 400 |
| | 138 (28) | F260 (30), | DOTP:DBT | |
| | | Formolon | (89.0) | |
| | | F28 (42) | | |
| 3 | Vestolit G | Formolon | 70:30 | 375 |
| | 138 (70) | F260 (30) | DOTP:DBT | |
| | | | (89.0) | |

The Plastisols in Table 3 were prepared by adapting the procedure for the preparation of Ex 2. Each sample also includes soya lecithin (1 g), and calcium oxide (1 g).

TABLE 3
Plastisol formulations for Comparative Ex 4-5, with
nonphosphate wetting agents/rheology modifiers.

| | | | | | Wetting |
|---|---|---|---|---|---|
| | 100 phr PVC | | | Celceram | Agent/ |
| | Copolymer | Homopolymer | | PV20A Fly | Rheology |
| Comp | PVC Resin | PVC Resin | | Ash Filler | Modifier |
| Ex # | (phr) | (phr) | Pz (phr) | (phr) | (phr) |
| 4 | Vestolit G | Formolon | 70:30 | 425 | Viscobyk |
| | 138 (28) | F260 (30), | DOTP:DBT | | 4010 (4.2) |
| | | Formolon | (89.0) | | |
| | | F28 (42) | | | |
| 5 | Vestolit G | Formolon | 70:30 | 364 | Lecithin |
| | 138 (28) | F260 (30), | DOTP:DBT | | (3.6) |
| | | Formolon | (89.0) | | |
| | | F28 (42) | | | |

The Plastisols in Table 4 were prepared by adapting the procedure for the preparation of Ex 2. Each sample also includes soya lecithin (1 g), calcium oxide (1 g), and the type of fly ash used was Celceram PV20A fly ash.

TABLE 4
Plastisol formulations for Comparative Ex 6-9,
with different plasticizer compositions.

| | | | | | Wetting |
|---|---|---|---|---|---|
| | 100 phr PVC | | | Celceram | Agent/ |
| | Copolymer | Homopolymer | | PV20A Fly | Rheology |
| Comp | PVC Resin | PVC Resin | | Ash Filler | Modifier |
| Ex # | (phr) | (phr) | Pz (phr) | (phr) | (phr) |
| 6 | Vestolit G | Formolon | 70:30 | 364 | Disperbyk |
| | 138 28 | F260 (30), | DOTP:B1046 | | 102 (3.6) |
| | | Formolon | (89.0) | | |
| | | F28 (42) | | | |
| 7 | Vestolit G | Formolon | DOTP (89.0) | 364 | Disperbyk |
| | 138 (28) | F260 (30), | | | 102 (3.6) |
| | | Formolon | | | |
| | | F28 (42) | | | |
| 8 | Vestolit G | Formolon | DOTP (89.0) | 364 | Disperbyk |
| | 138 (28) | F260 (30), | | | 102 (18.2) |
| | | Formolon | | | |
| | | F28 (42) | | | |
| 9 | Vestolit G | Formolon | DOTP (89.0) | 375 | Disperbyk |
| | 138 (70) | F260 (30) | | | 102 (3.8) |

Table 5 provides the dynamic viscosity, gel point and fusion temperatures for Ex 1-9 and Comp Ex 1-9.

TABLE 5
Properties of Ex 1-9 and Comp Ex 1-9.

| | 24 h Dynamic | 24 h Dynamic | | Fusion |
|---|---|---|---|---|
| | Viscosity | Viscosity | Gel Point | Point |
| Ex # | @ 2 rpm | @ 20 rpm | (° C.) | (° C.) |
| 1 | 20300 | 17700 | 76.0 | 122.0 |
| 2 | 10500 | 11450 | 75.0 | 115.0 |
| 3 | 18300 | 19300 | 74.0 | 115.0 |
| 4 | 24700 | 24800 | 74.0 | 115.0 |
| 5 | 29500 | 30550 | 72.0 | 119.0 |
| 6 | 18450 | 13500 | 72.0 | 112.0 |
| 7 | 18700 | 12850 | 66.0 | 108.0 |
| 8 | 24700 | 24800 | 74.0 | 115.0 |
| 9 | 16800 | 19400 | 65.0 | 108.0 |
| Comp Ex 1 | 74000 | 28600 | 69.0 | 116.0 |
| Comp Ex 2 | 162000 | 52600 | 68.0 | 118.0 |
| Comp Ex 3 | 62200 | 38850 | 62.0 | 109.0 |
| Comp Ex 4 | 45800 | 23900 | 70.0 | 123.0 |
| Comp Ex 5 | 43700 | 19950 | 68.0 | 120.0 |
| Comp Ex 6 | 13700 | 14100 | 85.0 | 120.0 |
| Comp Ex 7 | 14100 | 18350 | 92.0 | 129.0 |
| Comp Ex 8 | 89000 | 62600 | 92.0 | 132.0 |
| Comp Ex 9 | 57400 | 41800 | 71.0 | 120.2 |

As shown in Table 5, Ex 1-9 all have adynamic viscosity after 24 h at 2 rpm of less than 40,000 centipoise with agel point of less than 77° C. On the other hand, Comp Ex 1-9 either have aviscosity that is higher than 40,000 centipoise and/or higher than 77° C.

As will be appreciated by those skilled in the art, the plastisols disclosed herein can be modified by the use of differing amounts of the above-specified components, by substituting, adding or deleting components, and by modifying the above described processing steps. Such modification may alter the physical and chemical properties of the plastisol. Notwithstanding such modifications, the plastisol will be effective so long as the plastisol has a workable viscosity and gel point. Additionally, the plastisol will be effective if the fused plastisol is robust for its particular use.

1. A plastisol comprising:
(1) 100 parts per hundred resin (“phr”) of a polyvinyl chloride composition;
(2) 20 to 140 phr of a plasticizer component comprising:
(i) 10 to 40 wt % a highly solvating plasticizer, and
(ii) 60 to 90 wt % a general-purpose plasticizer;
(3) 0.1 to 19 phr of a phosphate ester; and
(4) 325 to 475 phr of a filler,
wherein the weight ratio of filler to phosphate ester is from 3250:1 to 25:1.

2. (canceled)

3. (canceled)

4. (canceled)

5. The plastisol of claim 1, wherein the phosphate ester is present from 0.5 to 3.0 phr.

6. The plastisol of claim 1, wherein the highly solvating plasticizer is dibutyl terephthalate.

7. The plastisol of claim 1, wherein the general-purpose plasticizer is chosen from di(2-ethylhexyl) terephthalate (“DOTP”), di-isononyl phthalate (“DINP”), di-2-ethylhexyl phthalate (“DOP”), or 1,2-cyclohexane dicarboxylic acid diisononyl ester (“DINCH”).

8. The plastisol of claim 1, wherein the general-purpose plasticizer is DOTP.

9. The plastisol of claim 1, wherein the PVC composition comprises a homopolymeric PVC polymer, a copolymeric PVC polymer, or combinations.

10. The plastisol of claim 9, wherein the PVC composition comprises from 10 to 100 wt % of the homopolymeric PVC polymer.

11. The plastisol of claim 1, wherein the filler comprises calcium carbonate, magnesium carbonate, silica, clay, mica, graphite, fly ash, zinc oxide, dirt, or calcium oxide.

12. The plastisol of claim 1 wherein the dynamic viscosity is in the range of from about 10,000 to about 40,000 centipoise as measured according to ASTM D2983 at 22° C. at 2 revolutions per minute (“rpm”) after standing for 24 hours.

13. The plastisol of claim 1, wherein the gel point is less than 77° C. as measured according to an adaptation of ASTM D2538 using a parallel plate rheometer.

14. An article comprising a fused plastisol prepared from the plastisol of claim 1.

15. The plastisol of claim 1, wherein the phosphate ester is 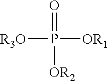
wherein R¹, R², R³ are independently chosen from hydrogen or 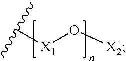
where each X₁ is independently an (C₂₋₄)alkylene;
each X₂ is independently an (C₁₋₂₀)alkyl; and
n is an integer from 1 to 20.

16. The plastisol of claim 15 wherein X₁ is ethylene; and X₂ is (C₆₋₁₈)alkyl.

17. The plastisol of claim 16, wherein X₂ is isotridecyl.
